(19) United States
(12) Patent Application Publication
(10) Pub. No.: US 2011/0174246 A1
(43) Pub. Date: Jul. 21, 2011

(54) METHOD FOR PRODUCING A CYLINDER CRANKCASE

(75) Inventors: Erik Graf, Stuttgart (DE); Guido Soell, Urbach (DE)

(73) Assignee: Daimler AG, Stuttgart (DE)

(21) Appl. No.: 12/595,835

(22) PCT Filed: May 6, 2008
(86) PCT No.: PCT/EP2008/003599

§ 371 Date: Oct. 14, 2009

(30) Foreign Application Priority Data
May 16, 2007 (DE) 10 2007 023 060.7

(51) Int. Cl. F02F 1/16; B22D 19/08; B22D 19/16; C22C 21/00; C23F 1/16

(52) U.S. Cl. 123/41.72; 164/94; 164/95; 148/437; 216/83

(57) ABSTRACT

The invention relates to a method for producing a light metal or plastic cylinder crankcase (2) of an internal combustion engine having a closed-deck design, comprising the steps of —casting a cylinder liner (4) using salt cores (6) corresponding at least to the cavities of the water jackets, —encapsulating the pre-cast cylinder liner in a pressure die-casting process in a light metal melt in order to achieve the cylinder crankcase (2) having a closed-deck design, wherein the cylinder liner (4) still contains the salt cores (6) at least in the water jackets during encapsulation.

The invention relates to a method for producing a cylinder crankcase according to claim 1 and a cylinder crankcase according to claim 6.

Cylinder crankcases in modern combustion engines are subjected to high mechanical and thermal loads. Due to the mechanical loads, a more wear-resistant material is usually provided for the cylinder paths than for the remaining crankcase. Concepts are known where cylinder liners consist of gray cast iron, heat-resistant Al alloys, as for example hypereutectic Al/Si alloys or fiber-reinforced Al alloys, and are cast in cylinder crankcases of cost-effective hypoeutectic Al alloys or Mg alloys. Recently, concepts of cylinder crankcases of plastics have also been pursued. A water jacket usually surrounds the cylinder sleeve, which jacket serves for cooling, especially the cylinder path. This water jacket is often open at the top on the cylinder side with crankcases which are produced with a pressure die-casting method, so that an open-deck design results. The water jacket which is open on the cylinder side results in that movable pushers are used in the metallic die-casting tool, which reproduce the water jacket after the casing. The pushers have to be withdrawn prior to the opening of the crankcase, this is why no undercuts are allowed to conflict with the withdrawal. This is why no closed spaces can be achieved with this technique.

The open water jacket leads to a limitation of the mechanical load capacity of the engines. Closed-deck designs are thus better, which comprise an at least partially closed water jacket. Such closed-deck crankcases can only be achieved with much difficulty in a cast-technological manner.

In DE 102 21 674 B4 and in DE 102 33 359 A1 are described cylinder crankcases in a closed-deck design. A cylinder liner is initially precast hereby. Due to the partially closed construction of the cylinder liner, it has to be produced by sand- or die-casting and not by pressure die-casting. The encapsulation of the pre-cast cylinder liner subsequently takes place by means of pressure die-casting.

The pressure die-casting method shows the more economic method for mass p[production compared to the sand- or die-casting, and should thus also be applicable to the production of the cylinder liner.

When the cylinder liner is cast in the pressure die-casting method, the problem arises that the cavities of the water jackets arranged in the cylinder liner show a mechanical weakening of the cylinder liner in such a manner that the outer wall of the water jackets can be pressed in by the casting melt.

It is the object of the present invention to provide a cylinder crankcase in a closed-deck design, which distinguishes itself by a lower production cost and improved casting quality compared to the state of the art.

This object is solved according to the invention by a method of producing a light metal or plastic cylinder crankcase (2) of an internal combustion engine in a closed-deck design with the following steps
casting a cylinder liner (4) using salt cores which correspond at least to the cavities of the water jackets,
encapsulating the pre-cast cylinder liner in a pressure die-casting method with a light metal melt for achieving the cylinder crankcase (2) in a closed-deck design with the characteristics of claim 1,
through a cylinder crankcase in a closed-deck design with the characteristics of claim 9,
and cylinder liners of a heat resistant Al alloy for casting into crankcases in a closed-deck design. Advantageous arrangements with convenient and non-trivial further developments of the invention are given in the respective dependent claims.

According to the method according to claim 1 for producing a cylinder crankcase having a closed-deck design, a cylinder liner is produced in a pressure die-casting process and placed into a further pressure die-casting tool, wherein an outer housing is subsequently cast around the cylinder liner. It is thereby essential that the cylinder liner does not have any larger cavities prior to the casting into the crankcase, as these are filled with salt cores according to the invention. The salt cores support the water jacket particularly effectively against the casting pressure. Furthermore, the salt cores prevent an undesired penetration of casting melt into the cavities at erroneously sealed casting mold contact surfaces. The salt core remains in the cylinder liner during the pressure die-casting of the cylinder crankcase, which improves the stability of the cylinder liner during the encapsulation—where high pressures occur—and increases the process safety. Additionally, noticeably thinner-walled channel structures of a water jacket can be realized in this manner.

It is a further considerable advantage of the invention compared to the state of the art that the achievement of the cylinder liner is more cost-effective with the pressure die-casting method than a non-pressurized casting method with large production engines. The surface quality is also considerably improved compared to sand-cast cylinder liners. Especially, no annoying adherences and backings of the casting surface with the sand of the sand molds are formed.

Cylinder liners are hereby meant to be the semi-finished product for insertion into a further casting tool. The cylinder liner forms the region of the cylinder bore and hereby comprises several cylinder bores in series, possibly with cylinder sleeves and a water jacket, and the webs between the cylinder bores.

It is a further special advantage of the method according to the invention that the salt core can be released in a simple manner and without residues after the first and also after the second casting process. Only hereby it will be possible to realize virtually closed cavities in the cylinder liner, as is especially necessary for closed-deck designs for the water jacket. The media connections of the coolant of the water jacket are sufficient for dissolving the salt core.

The salt cores are typically alkali chlorides, especially NaCl and/or KCl, on their own or in mixture. In an advantageous arrangement, dissolving additives or reinforcing additives are also included. Dissolving additives can for example be substances outgassing with the aqueous solvent, as for example Ca carbonates with acidic aqueous solutions. Reinforcing additives can for example be short mineral fibers.

It can be convenient to use acidic aqueous solutions as solvents, so as to support the complete removal of the salt core or the casting skin by etching the aluminum surface. Hereby, hydrochloric, acetic or citric solutions are especially advantageous.

Further advantages, characteristics and details of the invention result from the following descriptions a preferred embodiment and by means of the drawings; these show in:

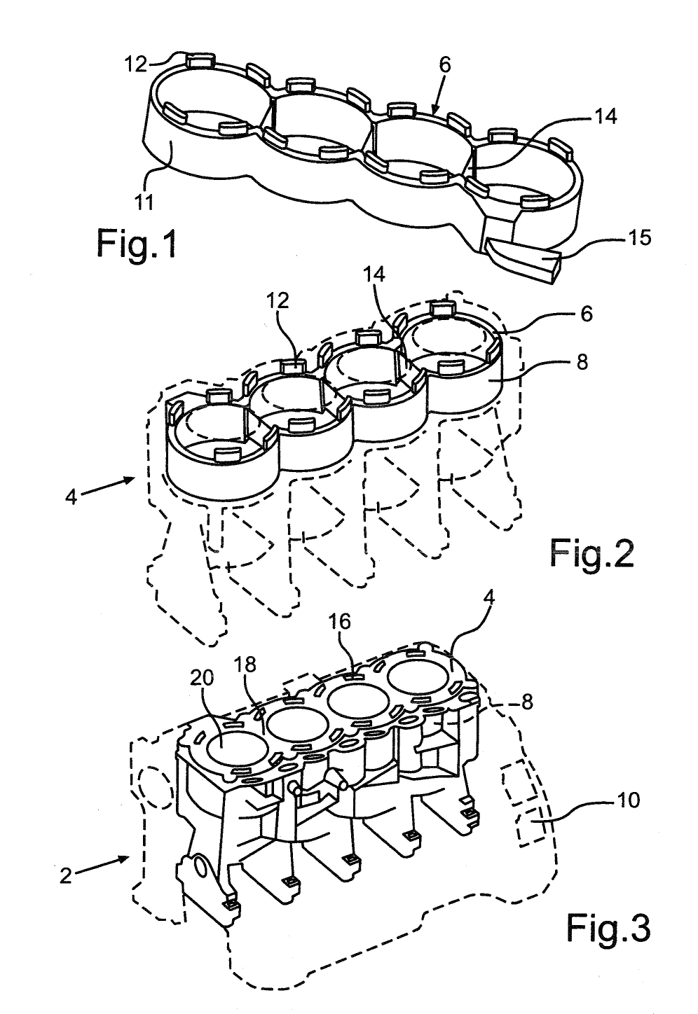

FIG. 1 a schematic perspective of a salt core for placing into a pressure die-casting tool and for achieving a cylinder liner;

FIG. 2 a schematic perspective of a cylinder liner cast with a pressure die-casting method with an encapsulated salt core; and in

FIG. 3 a schematic perspective of a cylinder crankcase with an encapsulated cylinder liner according to FIG. 2.

The method for producing a cylinder crankcase is based on the following method steps:

Initially, a salt core 6 shown in FIG. 1 in a schematic perspective is placed into a first pressure die-casting tool, not shown here. This first pressure die-casting tool serves for producing a cylinder liner 4, which is shown in FIG. 2 in a schematic perspective. The cylinder liner 4 with the salt core 6 is subsequently placed into a second pressure die-casting tool, also not shown, which serves for achieving a cylinder crankcase 2 shown in FIG. 3 in a schematic perspective. The cylinder liner 4 is hereby encapsulated by the casting metal and is surrounded by an outer housing 10 of the cylinder crankcase 4 in the final state.

Furthermore, the individual method steps and semi-finished products will be described in detail:

The core 6 according to FIG. 1 is a highly rigid salt core of an inorganic material including corresponding binders and curing agents, which is produced by a conventional core production method such as core shooting or pressing. This core 6 is soluble in water or another liquid.

The core 6 is designed in the example according to FIG. 1 in such a manner that it reproduces a water jacket 8 of a 4-cylinder crankcase 2. This comprises hereby annular jacket surfaces 11, which form cavities for the water jacket 8 in the finished cylinder crankcase 2, which water jacket surrounds the individual cylinder sleeves. The jacket surfaces 11 are connected by channels 14 at their center. The channels 14 are especially thin and sensitive structures, which can be achieved with difficulty in the pressure die-casting method. The salt core 6 further also comprises pinnacle-shaped elevations 12, which form passage openings 16 in the finished component (see FIG. 3). Through these passage openings 16, coolant can flow from the cylinder crankcase 2 into a cylinder head, not shown. The core 6 further comprises a water intake 15.

The first die-casting tool for producing the cylinder liner 4 is designed in such a manner that the core 6 can be placed therein and can be supported at the tool walls. The tool is hereby designed constructively in such a manner that no special bending torque peaks occur at the core 6 during the inflow of the casting metal. The core 6 remains undamaged during the pressure die-casting of the cylinder liner 4 and is removed with the cast cylinder liner 4. This semi-finished product resulting in such a manner is shown in FIG. 2.

In the next method step, the cylinder liner 4 is placed into the second pressure die-casting tool with the enclosed and encapsulated core 6, and is again encapsulated with casting metal. The fact that the core 6 is still contained in the cylinder liner 4 in the second casting method results in that the cylinder liner 4 withstands higher pressures during the pressure die-casting, whereby structures having thinner walls and which are more filigree can be achieved. Such fine channel structures can be realized with more difficulty with cylinder liners which are produced with the sand-casting method. Further, by leaving the core 6 in the cylinder core 4, it is prevented that melt enters and clogs the water jacket 8.

After the removal of this component, the core 6 is removed in a water bath or under high water pressure. The cylinder crankcase 2 results hereby, which is shown in FIG. 3. The cylinder crankcase 2 comprises the outer housing 10 and the cylinder liner 4. The cylinder liner 4 is passed through by cavities which correspond to the geometry of the core 4 and which form the water jacket 8 for conveying the coolant water during the engine operation. This water jacket 8 cannot be seen in more detail in the depiction according to FIG. 3. Only the passage openings 16 to the cylinder head, which can be attributed to the pinnacle-shaped elevations 12 of the core, 6 are shown in FIG. 3. Very thin water channels are guided below webs 18, which separate individual cylinder bores 20, which result from the channels 14 of the core 6, and which enable a direct cooling of the webs 18. Such a cooling has to be realized with an elaborate subsequent cooling bore with conventional cylinder crankcases.

In FIG. 3 it can also be perceived well that the produced cylinder crankcase is a “closed-deck” construction. In the upper region of the cylinder crankcase 2, only the passage openings 16 are present as openings, in contrast to conventional cylinder crankcases in the open-deck construction, where the entire water jacket is open towards the top.

Such a “closed-deck” construction cannot be realized with the conventional pressure die-casting method due to the pushers which are necessary. Such methods are very expensive with the cylinder liners described in the state of the art which are produced with the sand-casting method. By the use of the highly rigid salt core 6, very thin webs—such as the channels 14—can also be achieved with the pressure die-casting method. The rigidity, the mechanical load capacity and the temperature resistance of the cylinder crankcase distinguishes itself considerably from the state of the art with low production costs.

A further advantage of the described method consists in that a different material can be used for the cylinder liner 4 than for the outer housing 10. It is thus possible to use a highly rigid, or heat resistant, also hypereutectic aluminum alloy for the cylinder liner 4, by the use of which the further use of a separate cylinder sleeve, not described in detail, can possibly be dispensed. This would be a further cost advantage.

The outer housing 10, which itself is not subjected to the same high mechanical and thermal loads as the cylinder liner 4, can be achieved by a more economic aluminum alloy, magnesium alloy, or also by plastics. Among the plastics, plastics reinforced by glass or carbon fibers are preferred, wherein a BMC process or an RTM process is used here instead of a typical casting process.

When considering the possibility to achieve the cylinder liner 4 and the outer housing 10 of different alloys, it is additionally convenient for the reduction of the component weight to produce the outer housing 10 of a very light but not such a temperature-resistant magnesium alloy or plastics. The weight of the cylinder crankcase 2 is thus again reduced considerably.

The cylinder liner 4 can also contain vertical passage bores, which can possibly also be achieved by the core 6. Such passage bores can later contain threads for fastening to other components, or they can proceed as continuous bores from the cylinder head through the cylinder crankcase 2 and serve for fastening tie bars.

A further arrangement of the salt cores (6) for the water jacket provides surface structures in the form of grooves or recesses. Surface structures are hereby formed on the inner sides of the water jacket in a targeted manner. These can serve for improving the coolant flow. The surface structures are especially designed for the forced mixing or turbulence formation of the coolant flowing through. Cavitation triggered by local overheating of the coolant is hereby reduced, which can lead to damage of the water jacket. The residue-free removal of the casting core material within the inaccessible cavities of the water jacket is virtually impossible with conventional sand cores, in contrast to the salt cores used according to the invention.

A further arrangement provides that the salt cores of the water jacket comprise transverse channels or passages. Webs are hereby formed during the casting of the cylinder liner, which support both inner walls of the water jacket with regard to one another. These transverse channels of the salt core which form supporting webs in the water jacket after the casting of the cylinder liner can hardly be produced by conventional production methods. They contribute to an improvement of the stability of the liner and also to an improved mixing of the coolant.

A further aspect of the invention is a cylinder liner of a heat-resistant Al alloy for casting into crankcases in a closed-deck design, wherein the cylinder liner (4) contains salt cores (6) at least in the spaces of the water jacket. Such a cylinder liner is suited well for pressure die-casting due to its stability.

The cylinder liner preferably already contains the recesses and air holes filled with the salt cores, which are necessary for the later fastening to the cylinder head or bearing block.

A preferred arrangement provides that air holes for fastening screws are only arranged on the side of the cylinder head. The fastening on the side of the bearing block takes place with the encapsulation material of the crankcase housing.

### LIST OF REFERENCE NUMERALS

2 Cylinder crankcase
4 Cylinder liner
6 Salt core
8 Water jacket
10 Outer housing
11 Annular jacket surfaces
12 Pinnacle-shaped elevations
14 Channels
15 Water inlet
16 Passage openings
18 Webs
20 Cylinder bores

1. A method for producing a light metal or plastic cylinder crankcase (2) of an internal combustion engine having a closed-deck design and having water jacket caveties, comprising the following steps:
casting a cylinder liner (4) using salt cores (6) corresponding at least to the cavities of the water jackets, and
encapsulating the pre-cast cylinder liner in a pressure die-casting process in a light metal melt in order to achieve the cylinder crankcase (2) having a closed-deck design, wherein the cylinder liner (4) still contains the salt cores (6) at least in the water jackets during encapsulation.

2. The method according to claim 1, wherein a pressure die-casting method is used for producing the cylinder liner (4).

3. The method according to claim 1, wherein the salt core (6) for the water jacket is formed in one piece.

4. The method according to claim 1, wherein the cylinder liner contains further salt cores (6) prior to the encapsulation, which correspond to air holes for fastening screws or tie bars.

5. The method according to claim 1, wherein the salt cores (6) comprise transverse channels, which correspond to supporting webs in the water jacket after the casting of the cylinder liner.

6. The method according to claim 1, wherein the salt cores (6) for the water jacket comprise surface structures in the form of grooves or recesses.

7. The method according to claim 1, wherein all salt cores (6) remain in the cylinder liner (4) during the casting of the cylinder crankcase (2).

8. The method according to claim 1, wherein the salt cores (6) are removed from the cylinder crankcase (2) by acidic aqueous solutions after the pressure die-casting.

9. A cylinder crankcase in a closed-deck design, produced by a method according to claim 1, which comprises an outer housing (10) produced with a pressure die-casting method, in which is cast an inner cylinder liner (4) also produced with a pressure die-casting method, which comprises at least one integrated water jacket (8).

10. A cylinder liner of a heat-resistant Al alloy for casting into crankcases of light metal or plastics in a closed-deck design, wherein the cylinder liner (4) contains salt cores (6) at least in the spaces of the water jacket.

11. The cylinder liner according to claim 10, wherein the cylinder liner (4) contains salt cores (6) for forming air holes for tie bars or fastening screws.

12. The cylinder liner according to claim 11, wherein air holes for fastening screws are only arranged on the side of the cylinder head.
